(19) United States
(12) Patent Application Publication
(10) Pub. No.: US 2014/0112516 A1
(43) Pub. Date: Apr. 24, 2014

(54) Acoustic Device and Method of Manufacture

(71) Applicant: Knowles Electronics, LLC, Itasca, IL (US)

(72) Inventor: Mekell Jiles, Flossmoor, IL (US)

(73) Assignee: Knowles Electronics, LLC, Itasca, IL (US)

(21) Appl. No.: 14/046,134

(22) Filed: Oct. 4, 2013

Related U.S. Application Data
(60) Provisional application No. 61/711,419, filed on Oct. 9, 2012.

(51) Int. Cl. H04R 31/00; H04R 1/08; H04R 1/02

(52) U.S. Cl. CPC H04R 31/006; H04R 1/02; H04R 1/08
USPC 381/361

(57) ABSTRACT

An acoustic assembly includes an upper housing and a lower housing. The lower housing is coupled to the upper housing forming an interior cavity there between. At least one acoustic component is disposed within the cavity. At least one metalized area is formed in the upper housing or the lower housing. The at least one metalized area is in contact with the at least one acoustic component and is configured and arranged to provide an electrical connection between the acoustic component in the cavity and a customer that is exterior to the assembly. The at least one metalized area directly adheres to the upper housing or lower housing.

### CROSS REFERENCE TO RELATED APPLICATION

This patent claims benefit under 35 U.S.C. §119(e) to U.S. Provisional Application No. 61/711,419 entitled “An Acoustic Device and Method of Manufacture” filed Oct. 9, 2012, the content of which is incorporated herein by reference in its entirety.

### TECHNICAL FIELD

This application relates to acoustic devices and, more specifically, to their construction.

### BACKGROUND OF THE INVENTION

Various types of microphones and receivers have been used through the years. In these devices, different electrical components are housed together within a housing or assembly. For example, a receiver typically includes a coil, bobbin, stack, among other components and these components are housed within the receiver housing. Other types of acoustic devices may include other types of components.

The components that are housed in the interior of the housing must be electrically coupled to exterior elements in order to receive signals from, send signals to, or otherwise interact with these external devices. For instance, a receiver and its internal elements may be electrically coupled to an amplifier or microphone that are external to the receiver housing. To complete the electrical connection between the internal components and these external devices, wires are typically coupled (e.g., soldered) to the internal receiver components, the wires are next extended through the housing, and then an electrical connection is made with the exterior devices.

In addition, multiple conductors are often deployed in the interior of the housing and these conductors need to be coupled together. In one previous receiver, an interior coupling was made between a first wire (e.g., that was part of an electrical coil within the receiver housing) and a second wire (e.g., that coupled the coil wire to elements external to the receiver). To complete the coupling between the first and second wires, a “pigtail” connection was often used where a third wire was wrapped around the first wire and the second wire.

Still further, to make an electrical connection at the exterior of the assembly between wires from the receiver and external devices, an insulating board was typically required. The insulating board electrically isolated the wires from the body of the assembly or housing.

Unfortunately, these previous approaches suffered from various problems and drawbacks. For instance, connections between wires or the wires themselves might break. Additionally, both the “pigtail” and the insulation board were additional parts that increased the cost of the device. Further, installing the pigtail and/or the insulation board added steps in the manufacturing process still further increasing the cost of the device. As a result of these problems, user dissatisfaction with these previous approaches has increased.

### BRIEF DESCRIPTION OF THE DRAWINGS

For a more complete understanding of the disclosure, reference should be made to the following detailed description and accompanying drawings wherein:

FIGS. 1, 2, and 3 are various perspective views of an acoustic assembly (e.g., a receiver) that has metalized portions according to various embodiments of the present invention;

FIG. 4 comprises a cross-sectional view of one of the metalized areas of FIGS. 1-4 according to various embodiments of the present invention;

FIG. 5 is a flowchart showing one approach for constructing an acoustic assembly according to various embodiments of the present invention;

FIGS. 6-8 are perspective views of the bobbin according to various embodiments of the present invention.

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Acoustic assemblies (e.g., microphones and receivers) are provided that eliminate the need for various wires and other components (e.g., pigtails) that are used to make electrical connections between components internal to (i.e., located within) the housing of the device and components that are external to the housing. Further, additional external components (e.g., insulation boards attached to the housing) can also be eliminated using these approaches. The approaches provide devices that are reliable and the elimination of extra elements makes the devices easier and less costly to manufacture as compared to previous devices. Approaches for manufacturing these assemblies are also provided.

More specifically, assemblies are provided that have metalized areas that are incorporated into a housing and/or components associated with the housing (e.g., a bobbin). The metalized areas are patterned and arranged so as to provide an electrical connection (conductive path) between internal components of the acoustic assembly (e.g., the coil of a receiver assembly) and elements that are external to the acoustic assembly (e.g., an amplifier). Since the metalized areas are incorporated into the housing, wires required to complete electrical connections are eliminated.

Additionally, a process for constructing acoustic devices is provided. In one aspect, a housing is constructed or formed, for example, using conventional injection molding techniques. The housing may be constructed in one or more portions. There are several approaches for creating a metalized surface. Generally speaking, a plastic surface that is chemically receptive to plating is immersed. The plastic is either inherently receptive or made receptive through laser activation. Devices of this general type are referred to as Molded Interconnect Device (MIDs). In the case where the plastic is inherently receptive, a secondary outer jacket of not palatable plastic is molded over the palatable plastic to define the plated area. This is referred to as an additive process or 2-shot plating process.

In another example, laser defined plating may be employed. In this respect, a laser is directed at the areas to be metalized. Then, the assembly is immersed in a metal bath (e.g., a gold bath) and the metal adheres to the areas that have been hit by the laser. The internal components can be soldered to the housing and the device is ready to be used. The patterned metal areas (conductive paths) so formed provide electrical connection between internal components, and/or between internal components and external elements. On the exterior of the housing, the patterned metal areas may be in the form of pads that couple to external devices. It will be appreciated that the approaches described herein do not require the use of additional electrical components such as pigtails, additional wires, and/or insulation boards that have been needed in previous devices.

In one of these embodiments, a receiver incorporates a selectively metalized bobbin or metal flanges. Areas of the housing are also selectively metalized. The metalized areas provide a complete electrical connection between elements coupled to the bobbin (e.g., a coil) or metal flanges and elements external to the housing (e.g., external amplifiers to mention one example). The approaches described herein extend the benefits of injection molded components (e.g., low cost and easy manufacturing) by incorporating integrated connectivity (i.e., using the metalized areas to make electrical connections between elements). The elimination of extra wires makes the present assemblies more durable and reliable since the devices are often exposed to jarring forces that may break wires and/or the connections between wires.

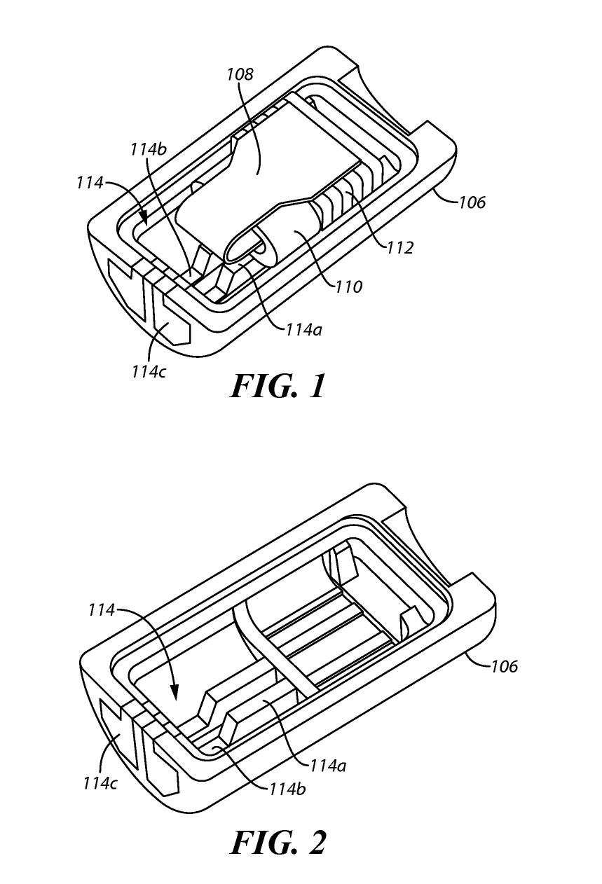

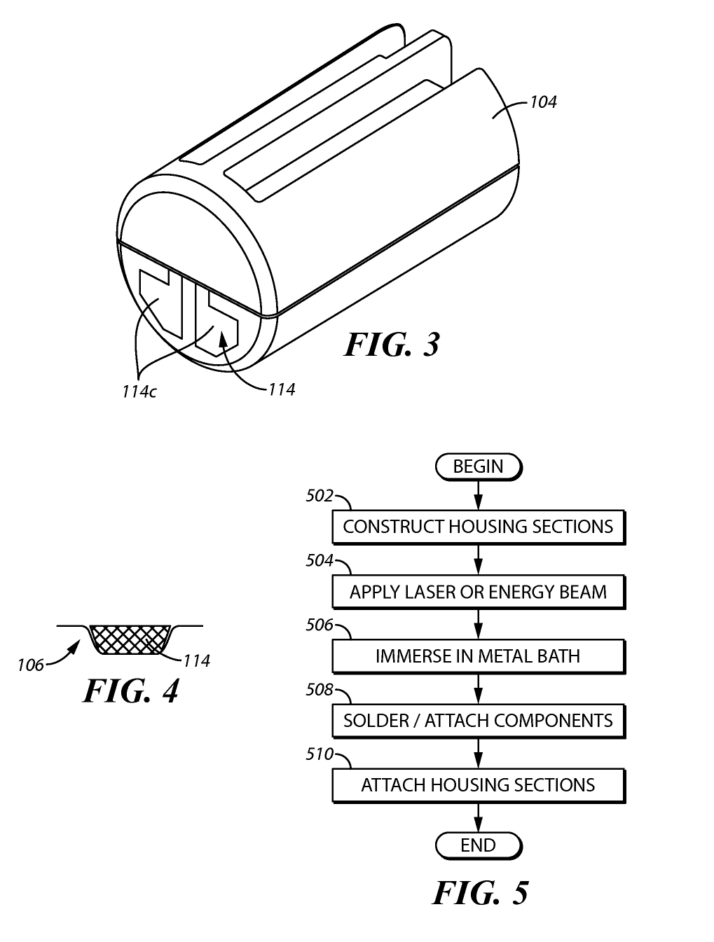

Referring now to FIGS. 1, 2, 3, and 4, an acoustic assembly 102 (in this case, a receiver) includes an upper housing 104 and a lower housing 106. Disposed within the assembly are a reed 108, a coil 110, and a stack 112. In this example, the coil 110 is disposed about the reed 108. As the coil 110 is excited, the reed 108 moves, which in turn moves other components (not shown) to convert electrical energy into sound so that a user can hear the sound. The stack 112 acts a return path for the magnetic circuit. It will be appreciated that although the acoustic devices described herein are receivers, the component interconnect methods described herein can also be applied to other types of acoustic devices such as microphones.

As shown in these figures, selective areas 114 of the assembly are metalized. The metalized areas provide a conductive electrical path from the exterior of the assembly to the electrical components in the interior of the assembly and vice versa. The selective areas 114 of the case are metalized using a process such as Microscopic Integrated Processing Technology (MIPTEC). In one aspect, in the MIPTEC process, a laser is used to treat the area of interest causing the treated area to be receptive to electroplating metals. The case is immersed in a metal bath and the metal adheres to the case. The selective areas 114 may include first portions 114a that can be connected to the bobbin, second portions 114b that are disposed along the base of the housing, and third portions 114c that are configured as contact pads to allow the assembly 102 to electrically couple to an external device such as an amplifier or microphone.

In one specific example, the metalized areas are gold or any other electrically conductive platable material. As mentioned, the metalized areas may be formed by using electroless (immersion) or electroplating approaches. The coil with the metalized bobbin, stack and reed assembly (motor assembly) are connected together and to the housing using conventional soldering techniques. The soldering occurs between the metalized bobbin (or coil flanges) and the metalized areas of the case, providing a connection to the exterior of the case.

As shown in greater detail in FIG. 7, the coil is actually wound around a bobbin made of metalized plastic—whereas the coil wire is terminated to the metalized areas on the bobbin body 604. The metalized bobbin thus provides metalized termination areas for the coil. An alternate design provides for metalized coil flanges to be attached to the faces of the coil, thus providing similar termination sites for the coil. The interior of the housing portions 104 and 106 can be further metalized to provide for electrical shielding.

The metalization pattern is defined by a laser (or some other form of directed energy) which is applied according to the desired pattern. In other examples, a “two-shot” approach of defining metalized areas may be used. By “pattern” and as used herein, it is meant the shape, dimensions, and/or relative positioning of the metalized path. As shown especially in FIG. 4, the metalized area includes metal 114 deposited on the housing 104 or 106. The laser-activatable thermoplastic has a special additive in the form of an organic metal complex, which is activated by a physico-chemical reaction induced by the focused laser beam. This cracks open the complex compounds in the doped plastic, and breaks off the metal atoms from the organic ligands. These act as nuclei for reductive copper coating. In addition to activation, the laser also creates a microscopically irregular surface. The laser only ablates the polymer matrix, not the fillers added to the plastic. This creates microscopic pits and undercuts in which the copper is firmly anchored during metallization.

It will be appreciated that the metal may be disposed in various patterns on the housing. For example, the metalized areas may have a predefined thickness. Further, the metalized areas may be disposed so as to avoid certain components in the housing while arranged to contact other components. The metalized areas may be arranged to provide the shortest path between two points or arranged to provide a longer path. The metalized areas may be disposed in a pattern that requires a minimum of laser movement or may be provided in areas that allow a clear line of sight from the laser.

Using the present approaches, it will be appreciated that an insulating board is not needed since the metalized areas are electrically isolated from each other by the case. Furthermore, it will be appreciated that electrical pigtails (connections from the thinner fragile coil wire to the thicker coil lead wire) are also not needed to make the connection from the coil to the termination of the receiver since the internal metalized conductive paths provide the electrical connection and not a wire. The elimination of either or both of these elements provides integrated connectivity and replaces terminal boards. By the term “integrated” and as used herein, it is meant that the electrical connections are incorporated, embedded, or disposed with or into the housing (or bobbin or other element) such that separate, loose electrical wires are not needed and can be eliminated.

In other aspects, nanocyrstalline ferromagnetic coating is applied to the entire housing and used in applications where magnetic shielding is required. In so doing, shielding is provided without adding significantly to the thickness of the walls. Other examples of coatings are possible. The plating thickness is controlled by duration in plating bath-process limitations as used in other electroless or electroplating processes.

Referring now to FIG. 5, one example of an approach for constructing an acoustic assembly is described. At step 502, the acoustic housing assembly housings section(s) are constructed, for instance, using an injection molding process where one or more sections (e.g., an upper section and a lower section) are formed in molds. These sections may be constructed of a plastic that is an insulator.

At step 504, a laser beam (or any other form of directed energy) is applied to the areas to be metalized in some or all of the sections. A control program may be programmed by a user to aim and fire the laser at particular areas to form the predetermined pattern. For example, the areas to be metalized may be selected so as to avoid certain components in the housing while in other examples the areas are arranged to contact certain other components. The metalized areas may be arranged to provide the shortest path between two points or arranged to provide a longer path. The metalized areas may be selected so that the laser (in creating these areas) has a clear firing line or such that movement of the laser is minimized. The patterns may be selected to accomplish other goals as well.

At step 506, the assembly with the laser applied areas is immersed in a metal bath. For example, the housing sections may be immersed in a gold bath. This adheres the gold to these areas.

At step 508, after the assembly has been removed the electrical components may be soldered to the housing and to the metalized areas.

At step 510, the housing sections are attached. For example, this may be accomplished using glue, soldering, or any other fastening approach. The device is now ready to be installed in an acoustic system.

It will be appreciated that other approaches may also be used. For example, in one alternative approach a part can be metalized. A laser is applied to create the pattern on the part. The part is then immersed in a bath to remove the metal part thereby leaving the desired pattern.

In still another alternative approach, after molding of the primary part is complete, a secondary molding forms the shape of the part other than the desired pattern. A catalyst is then applied and the secondary part is melted. The catalyst remains on the desired pattern. A plating is then applied to the catalyst forming the metalized area of the desired pattern.

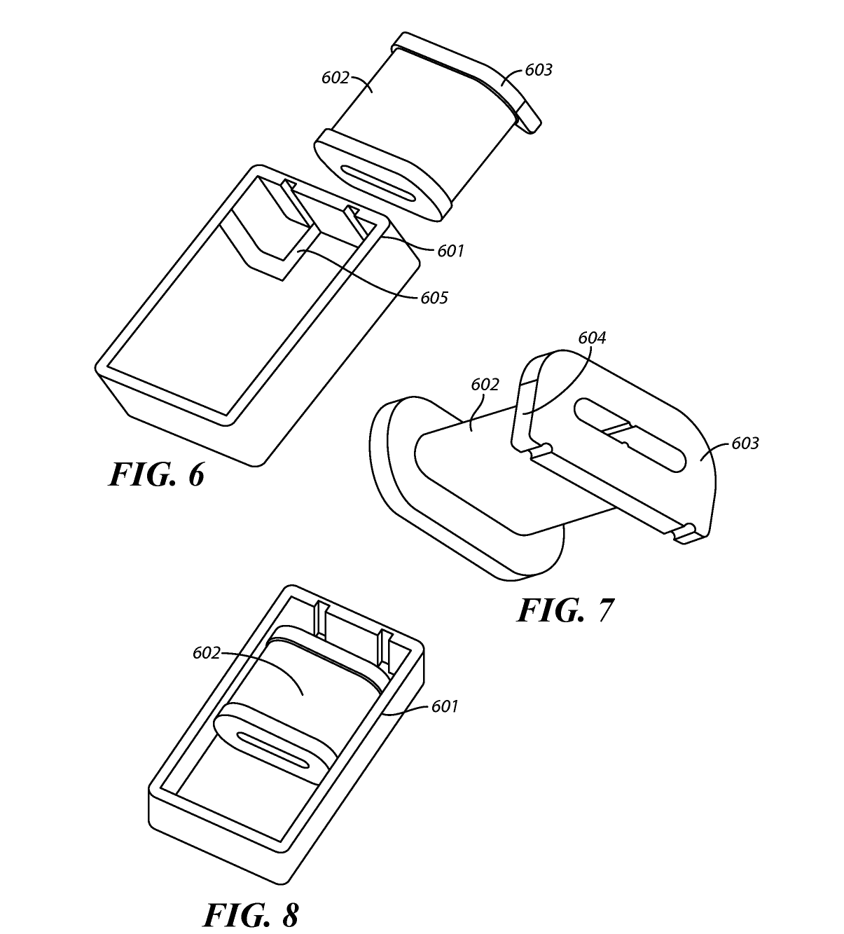

Referring now to FIGS. 6-8, one example of a bobbin structure is described. A coil 602 is disposed within a metalized case 601. The coil 602 is wound around a metalized bobbin 603. Alternatively, the coil may include metalized flanges and the bobbin may be omitted. The bobbin 603 includes a metalized termination 604. The case 601 includes a metalized traces and termination 605. The metalized termination 604 mates with the metalized traces 605.

It will be appreciated that using the present approaches, electrical pigtails are not needed to provide electrical connections within the housing and many interior wires can also be eliminated. Also, no insulation board is needed on the exterior of the housing. These approaches save the cost of these components and makes assembling the housing much easier since, for instance, wires and their connections do not need to be made. Additionally, the remaining area of the interior of the housings 104 and 106 (not connected to electrical traces) can be metalized to provide shielding properties for the device.

Preferred embodiments of this invention are described herein, including the best mode known to the inventors for carrying out the invention. It should be understood that the illustrated embodiments are exemplary only, and should not be taken as limiting the scope of the invention.

What is claimed is:

1. An acoustic assembly, the acoustic assembly comprising:
an upper housing;
a lower housing coupled to the upper housing and forming an interior cavity there between;
at least one acoustic component disposed within the cavity;
at least one metalized area formed with the upper housing or the lower housing, the at least one metalized area being in contact with the at least one acoustic component and being configured and arranged to provide an electrical connection between the acoustic component in the cavity and a customer that is exterior to the assembly, the at least one metalized area directly adhering to the upper housing or lower housing.

2. The acoustic assembly of claim 1 wherein the at least one acoustic component comprises one or more of a reed, a coil, a bobbin, and a stack.

3. The acoustic assembly of claim 1 wherein the at least one acoustic component comprises a bobbin and the at least one metalized area comprises a first metalized area, a second metalized area, and a third metalized area.

4. The acoustic assembly of claim 1 wherein the first metalized area that is incorporated into the bobbin, the second metalized are disposed at a base of the lower housing, and the third metalized area are contact pads at an exterior surface of the lower housing.

5. The acoustic assembly of claim 1 wherein the at least one metalized area is formed at least in part by a laser.

6. The acoustic assembly of claim 1 wherein the coil is wound around the bobbin.

7. The acoustic assembly of claim 1 wherein the metalized bobbin provides metalized termination areas for the coil.

8. The acoustic assembly of claim 1 wherein metalization on the face of the upper housing and the lower housings seals or connects the upper and lower enclosure section through soldering.
